(19) United States
(12) Patent Application Publication
(10) Pub. No.: US 2011/0148823 A1
(43) Pub. Date: Jun. 23, 2011

(54) TOUCH PANEL

(76) Inventor: Yang-Lin CHEN, Taoyuan Hsien (TW)

(21) Appl. No.: 12/957,994

(22) Filed: Dec. 1, 2010

(30) Foreign Application Priority Data
Dec. 22, 2009 (TW) 98144066

(51) Int. Cl. G06F 3/042

(52) U.S. Cl. 345/176

(57) ABSTRACT

A touch panel includes a first substrate, a first transparent conductive film and a first stack layer. The first transparent conductive film having a first pattern is formed at one side of the first substrate. The first stack layer having the first pattern is stacked on the first transparent conductive film, wherein the first stack layer is preferably composed of alternately stacked high-refraction-index and low-refraction-index layers.

### CROSS REFERENCE TO RELATED APPLICATIONS

This Application claims priority of Taiwan Patent Application No. 0981440066, filed on Dec. 22, 2009, the entirety of which is incorporated by reference herein.

### BACKGROUND OF THE INVENTION

1. Field of the Invention

This invention generally relates to a touch panel and more particularly to a touch panel with a stack layer formed on a transparent conductive film to reduce average reflectivity difference between a pattern region and a non-pattern region of the transparent conductive film, so that a human eye cannot identify patterns in the pattern region.

2. Description of the Related Art

Currently the transparent conductive film of the capacitive touch panel has patterns. The pattern regions and non-patent regions have different reflectivity, where the reflectivity difference can be easily observed by a human eye. Therefore, appearance of products is affected.

The transparent conductive film of the current touch panel is deposited on a transparent substrate, wherein the light of a shorter wavelength has high reflectivity and the light of a longer wavelength has low reflectivity. Taking a glass substrate deposited with 25nm ITO film for an example, a reflective light at the front side is colorful and great (generally, a substrate has a single-side reflectivity of about 4%).

For example, a touch panel including stack layers of a PET substrate, a 20 nm ITO and a adhesive layer (n=1.5) has an average reflectivity of about 1.596% when incident light has a wavelength of 400˜700 nm, wherein average reflectivity in the non-pattern region is about 0.279 and reflectivity difference between a pattern region and a non-pattern region is about 1.317%. A human eye can see patterns in the pattern region according to the reflectivity difference between the pattern region and the non-pattern region. In general, when incident light has a wavelength of 400-700 nm and the reflectivity difference is under 0.3%, the patterns cannot be identified by a human eye.

FIG. 1 shows a cross sectional view of a touch panel disclosed in U.S. patent publication number US2005/0083307. As shown in FIG. 1, a coating layer 51 is deposited on a substrate 50 and a transparent conductive film 52 with patterns is deposited on the coating layer 51, wherein the coating layer 51 has a refraction index lower than the substrate 50 and the transparent conductive film 52. The application has a stack structure of a substrate, a coating layer, a TCO and a filling layer 53, wherein the reflectivity is arranged by the type “low/high/low” to reduce reflectivity. However, the technique is only effective for a plastic substrate 50, such as a polyethylene terephthalate (PET) substrate.

When the substrate is a glass substrate and the structure is a glass substrate/30 nm thick SiO₂/20 nm thick ITO/30 nm thick SiO₂/adhesive layer (n=1.5), an average reflectivity (incident light has a wavelength 400 nm˜700 nm) is about 1.858%, an average reflectivity in a non-pattern region is about 0.019% and an average reflectivity difference between the pattern region and the non-pattern region is about 1.839%, as shown in FIG. 2. The improvement is not good enough, so that the patterns are still visible by the human eye.

### BRIEF SUMMARY OF INVENTION

An object of the invention is to reduce reflectivity difference of a pattern region and a non-pattern region of a transparent conductive film, so that the human eye can not see patterns in the pattern region.

Another object of the invention is to form a stack layer on a transparent conductive film to reduce reflectivity difference of a pattern region and a non-pattern region on various transparent substrate or structure, so that the human eye can not see patterns in the pattern region and design flexibility may be increased.

A further object of the invention is to form a stack layer on a transparent conductive film to protect the transparent conductive film from being scratched.

A yet further object of the invention is to form a stack layer on a transparent conductive film to isolate the transparent conductive film from coming into contact with oxygen for improving conductivity and uniformity of the transparent conductive film and preventing degradation of the transparent conductive film.

In order to achieve the objects described above, the invention provides a touch panel including a first substrate, a first transparent conductive film having a first pattern and formed at a side of the first substrate, and a first stack layer having the first pattern stacked on the first transparent conductive film, wherein the first stack layer preferably includes alternately stacked high-refraction-index and low-refraction-index films.

The first stack layer is a composite layer and includes alternately stacked high-refraction-index and low-refraction-index films. Preferably, the first stack layer includes alternately stacked silicon oxide thin films and silicon nitride thin films.

According to the description above, the invention can reduce reflectivity difference of a pattern region and a non-pattern region, so that the human eye can not see patterns in the pattern region, by forming a stack layer having the same pattern on the pattern region of the transparent conductive film.

The stack layer formed on the transparent conductive film can also protect the transparent conductive film from being scratched or protect lines form cutting.

The stack layer formed on the transparent conductive film can further isolate the transparent conductive film from coming into contact with oxygen to improve conductivity and uniformity of the transparent conductive film and prevent degradation of the transparent conductive film.

### BRIEF DESCRIPTION OF DRAWINGS

The invention can be more fully understood by reading the subsequent detailed description and examples with references made to the accompanying drawings, wherein,

FIG. 1 shows a cross sectional view of a conventional touch panel.

FIG. 2 shows a spectrum diagram of a pattern region and a non-pattern region of a touch panel.

FIG. 3 shows a cross sectional view of a touch panel of a preferred embodiment of the invention.

FIG. 4 shows a top view of the touch panel of FIG. 3.

FIG. 5 shows a cross sectional view of a touch panel of a first application example of the invention.

FIG. 6 shows a spectrum diagram with reflectivity as a function of reflection of a touch panel.

FIG. 7 shows a cross sectional view of a touch panel of a second application example of the invention.

FIG. 8 shows a cross sectional view of a touch panel of a third application example of the invention.

FIG. 9 shows a top view of patterns of the two-layer transparent conductive films of the invention.

FIG. 10 shows a cross sectional view of a touch panel of a fourth application example of the invention.

FIG. 11 shows a cross sectional view of a touch panel of a fifth application example of the invention.

FIG. 12 shows a cross sectional view of a touch panel of a sixth application example of the invention.

FIG. 13 shows a cross sectional view of a touch panel of a seventh application example of the invention.

FIG. 14 shows a cross sectional view of a touch panel of an eight application example of the invention.

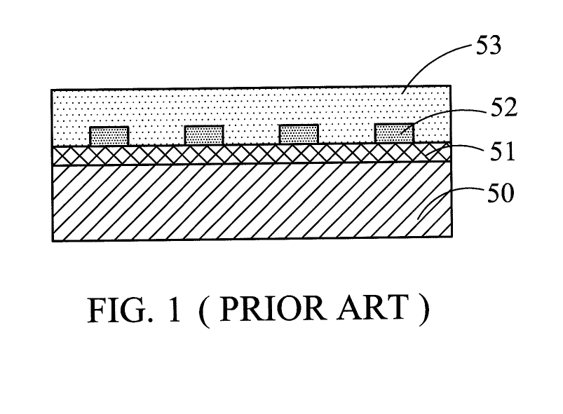

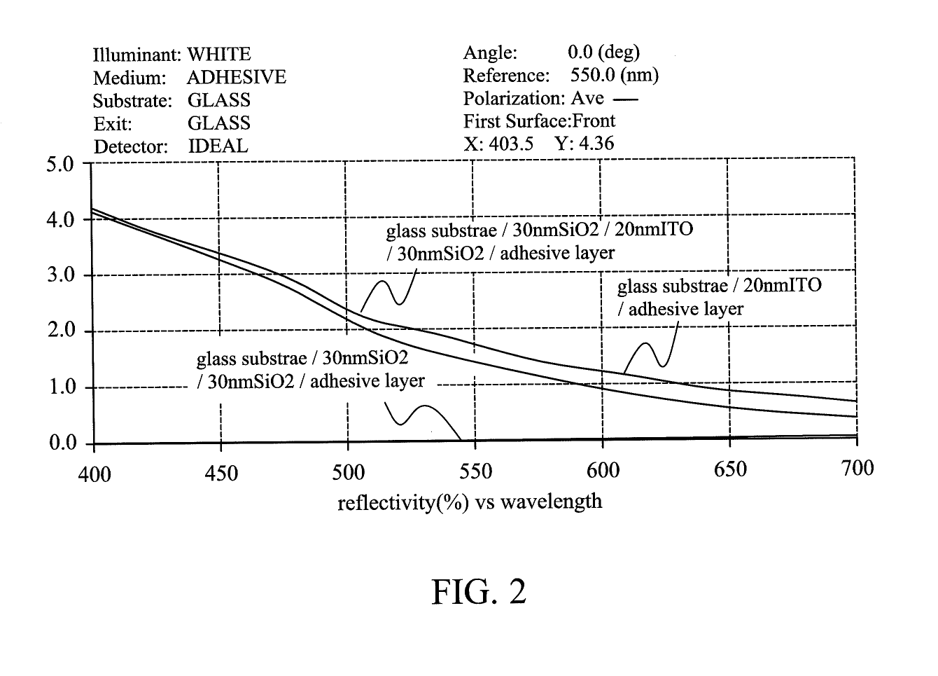

### DETAILED DESCRIPTION OF INVENTION

A touch panel of a preferred embodiment of the invention is discussed in the following paragraph in accordance with related figures, wherein the same elements use the same symbols.

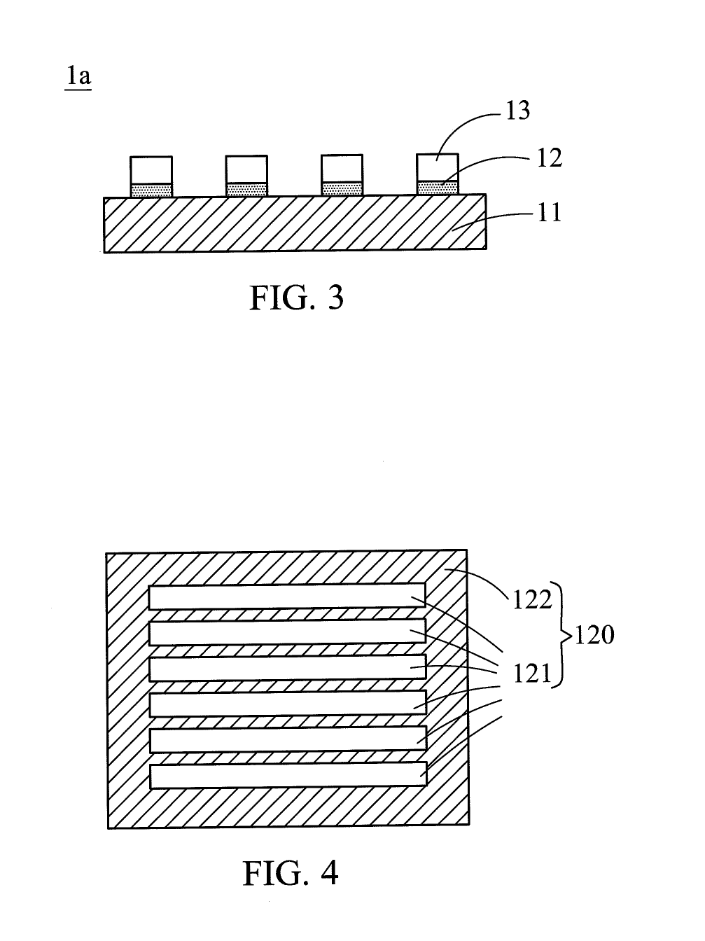

FIG. 3 shows a touch panel of a preferred embodiment of the invention. FIG. 4 shows a top view of FIG. 3. The touch panel 1 a is a capacitive touch panel including a first substrate 11, a first transparent conductive film 12 and first stack layer 13.

The first substrate 11 can be a glass substrate, a plastic substrate or a transparent insulating substrate. The plastic substrate can be polyethylene (PE), polycarbonate (PC) or polyethylene terephthalate (PET). The first transparent conductive film 12 has a first pattern 120 and is formed on the first substrate 11. The first transparent conductive film 12 can include indium tin oxide, indium zinc oxide, aluminum zinc oxide, gallium zinc oxide, zinc oxide, tin oxide or combinations thereof. As shown in FIG. 4, the first pattern 120 includes a pattern region 121 and a non-pattern region 122. The pattern region 121 of the first transparent conductive film 12 includes a plurality of first transparent conductive strips acting as a touch sensitive film of the touch panel. The first stack layer 13 is a composite layer and also has the first pattern 120 as the first transparent conductive film 12. The first stack layer 13 is formed on the first transparent conductive film 12. Size of the first stack layer 13 and the first transparent conductive film can vary with respect to different process parameters. The first stack layer 13 includes alternately stacked high-refraction-index and low-refraction-index layers. The first stack layer 13 is formed of transparent conductive materials including niobium oxide, titanium oxide, tantalum oxide, zirconium oxide, silicon oxide, silicon nitride, magnesium oxide, cryolite, magnesium fluorine or combinations thereof. For example, the first stack layer 13 can be alternately stacked silicon oxide and silicon nitride thin films.

### First Application Example

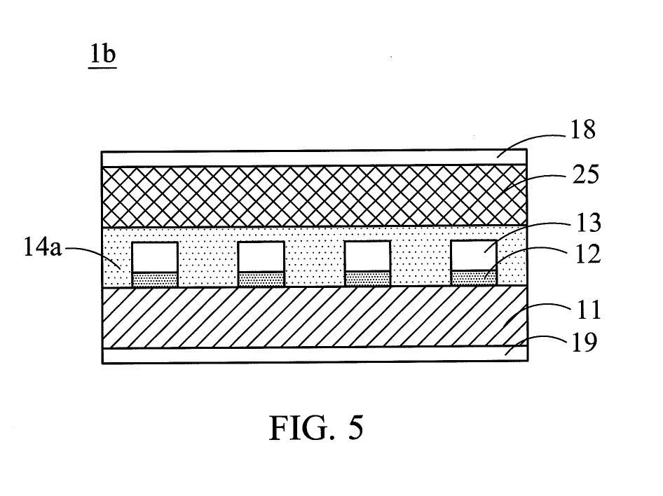

FIG. 5 shows a cross sectional view of a touch panel of a first application example of the invention. The primary portion of the touch panel 1b is the same as the touch panel 1a and is not described herein.

The touch panel 1b further includes a top substrate 25 and a first filler layer 14a. The first filler layer 14a is used to be filled into the space at sides of the first transparent conductive film 12 and the first stack layer 13 over the first substrate 11. The top substrate 25 can sustain rubbing generated from a finger or an external force touching the touch panel 1b. The top substrate 25 can be a glass substrate, a plastic substrate or a transparent insulating substrate. The materials of the top substrate 25 and the first substrate 11 can be the same or different, and are not described herein again. The first filler layer 14a can be a dielectric layer, an adhesion layer or a pressure-sensitive adhesive. The material of the first filler layer 14a is required to have close or matching refraction indices with the first substrate 11 and the top substrate 25. The refraction index of the first filler layer 14a preferably is between 1.3 to 1.8, and can be determined according characteristics of the substrate.

As shown in FIG. 5, the touch panel 1b can further include a top layer 18 formed on the top substrate 25. The top layer 18 can be a single anti-reflection layer, a anti-reflection multi-layer, an anti glare layer, an anti subbing layer, a hardening layer or fingerprint preventing layer. The invention is not limited thereto. The top layer 18 can be optionally arranged.

As shown in FIG. 5, the touch panel 1b can further include a bottom layer 19 formed under the first substrate 11. The bottom layer 19 can be a second transparent conductive film for preventing noise, a single anti-reflection layer, a anti-reflection multi-layer, an anti-glare layer, an anti subbing layer, a hardening layer or fingerprint preventing layer. The invention is not limited thereto. The bottom layer 19 can be optionally arranged.

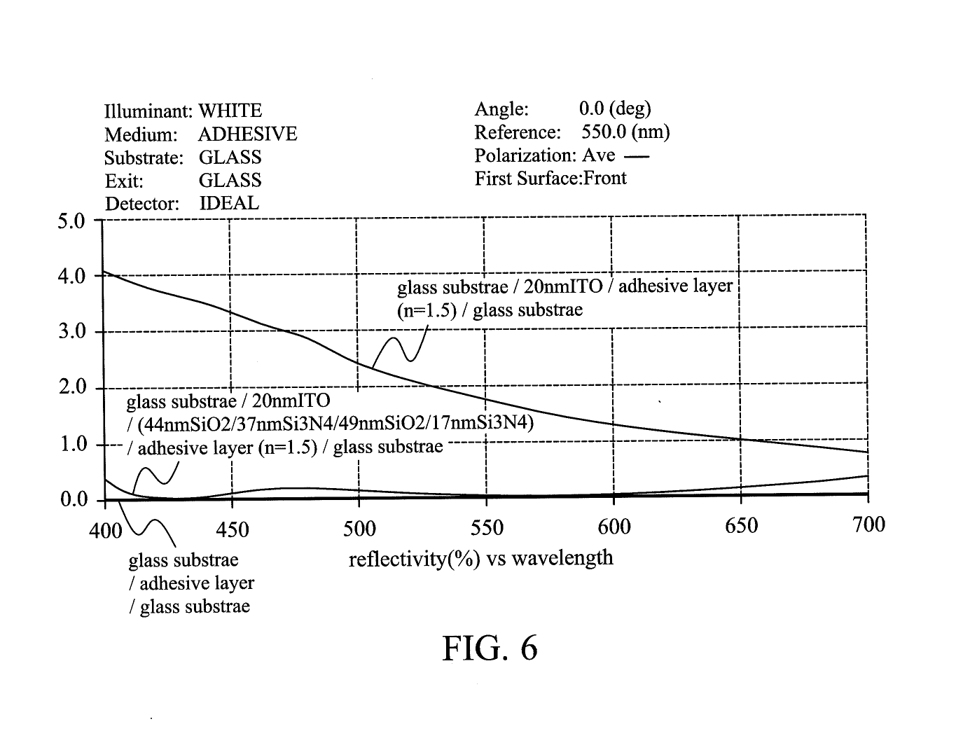

FIG. 6 shows a spectrum diagram with reflectivity as a function of reflection of a touch panel 1b. As shown in FIG. 6, when the touch panel 1b has a structure glass/adhesive layer (n=1.5)/glass in the non-pattern region, the average reflectivity with respect to an incident light with wavelength of 400 nm˜700 nm is about 0%. When the touch panel does not include the stack-layer structure of the invention in the pattern region and the structure is glass substrate, 20 nm ITO/adhesive layer (n=1.5)/glass substrate, the average reflectivity with respect to an incident light with wavelength of 400 nm˜700 nm is about 2.054%. When the touch panel includes the stack-layer structure of the invention in the pattern region and the structure is glass substrate/20 nm ITO/(44 nm SiO₂/37 nm Si₃N₄/49 nm SiO₂/17 nm Si₃N₄)/adhesive layer (n=1.5)/glass substrate, the average reflectivity with respect to an incident light with wavelength of 400 nm˜700 nm is about 0.126%. Therefore, it would be very difficult for patterns in the pattern region to be seen by the human eye.

### Second Application Example

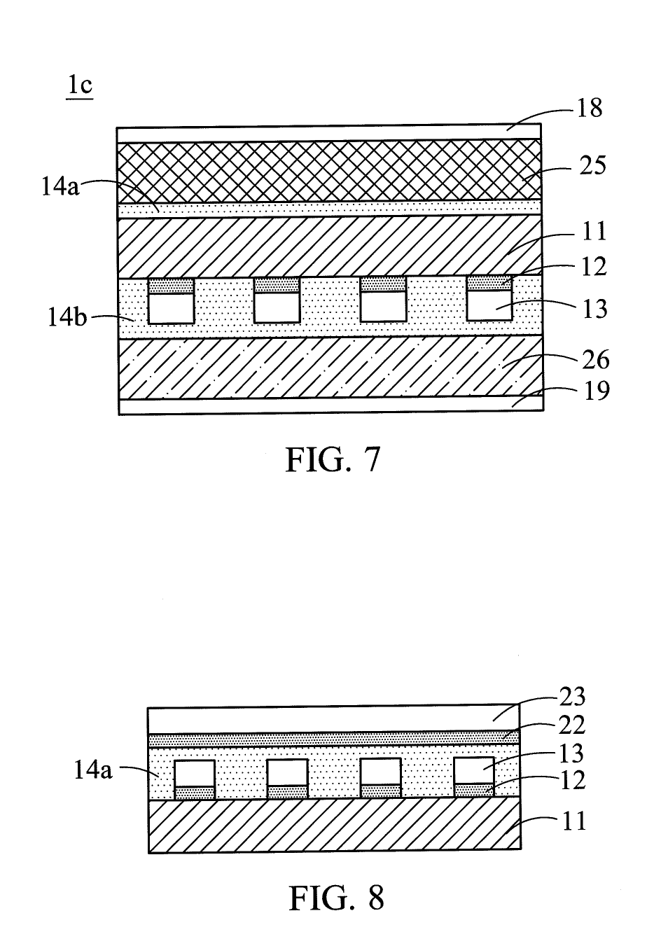

FIG. 7 shows a cross sectional view of a touch panel of a second application example of the invention. The touch panel 1c includes a first substrate 11, a transparent conductive film 12 and a first stack layer 13. The first substrate 11, the transparent conductive film 12 and the first stack layer 13 are the same as those of the touch panel 1a shown in FIG. 3, so they are not described in detail again. The first substrate 11 is placed upside down for the first transparent film 12 and the first stack layer 13 at a side of the first substrate 11 to face downward. If the first substrate 11 is not rigid or hard-wearing enough, a top substrate 25 can be placed on another side of the substrate, wherein the top substrate 25 and the first substrate 11 are bonded by a first filling layer 14a. A top layer 18 can also be placed on the top surface of the second substrate 15. Alternatively, a top substrate 25 does not have to be provided and the top layer 18 can be directly disposed at another side of the first substrate 11. Furthermore, the touch panel of yet another embodiment of the invention can be without a top layer 18. The materials of the top substrate 25 and the top layer 18 are described in the first application example, and thus are not described again.

The touch panel 1c further includes a bottom substrate 26 and a second filler layer 14b bonded under the side of the first substrate 11 having the first transparent conductive film 12 and the first stack layer 13. The bottom substrate 26 can be a glass substrate, a plastic substrate or a transparent insulating substrate. The bottom substrate 26, the top substrate 25 and the first substrate 11 can have the same material and different materials. Details are not described again. A bottom layer 19 can further be placed on the bottom surface of the bottom substrate 26. The material of the bottom layer is described in the first application example, and thus is not described again.

### Third Application Example

FIG. 8 shows a cross sectional view of a touch panel of a third application example of the invention. The touch panel 1d has two transparent conductive films, which includes a first substrate 11, a first transparent conductive film 12 and a first stack layer 13. The first substrate 11, the first transparent conductive film 12 and the first stack layer 13 are the same as those of the touch panel 1a shown in FIG. 3, and thus are not described again.

The touch panel 1d further includes a first filler layer 14a formed at a side of the first substrate 11 having the first transparent conductive film 12 and the first stack layer 13. The material of first filler layer 14a is described in the previous application example, and thus will be not described again.

The touch panel 1d further includes a second transparent conductive film 22 and a second stack layer 23 sequentially formed on the first filler layer 14a . The second transparent conductive film 22 and the second stack layer 23 have the same patterns (referred to second pattern). The second transparent conductive film 22 and the second stack layer 23 can have slightly different sizes due to process requirements. The second transparent conductive film 22 has the same material as that of the first transparent conductive film 12, and thus is not described again.

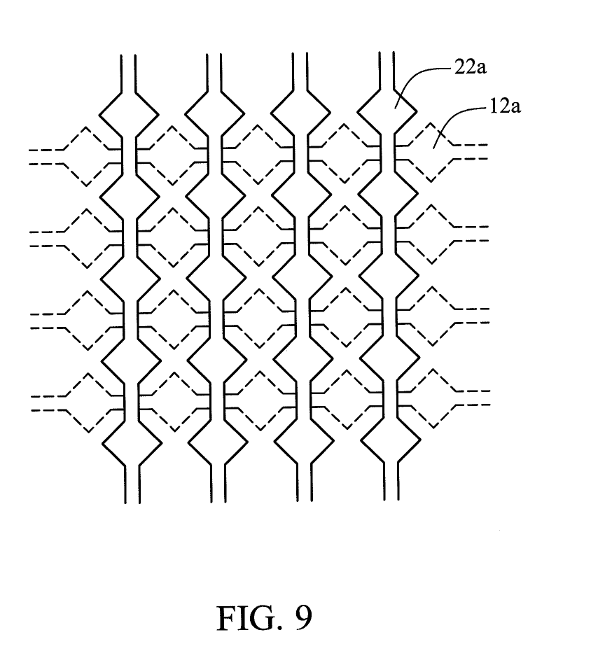

FIG. 9 shows a top view of patterns of the two-layer transparent conductive films. A first pattern of the first transparent conductive film 12 includes at least one first transparent conductive strip 12a extending in a first direction, wherein each transparent conductive film 12a can be serially connected rhombuses extending in a first direction. However, the invention is not limited thereto. A second pattern of the second transparent conductive film 22 includes at least one second transparent conductive strip 22a extending in a second direction, wherein each transparent conductive film 22a can be series connected rhombuses or other shapes extending in a second direction. However, the invention is not limited thereto. The first direction can be perpendicular with the second direction to act as a touch sensitive film of the touch panel 1d for conforming to of multi-points touching control requirements.

### Fourth Application Example

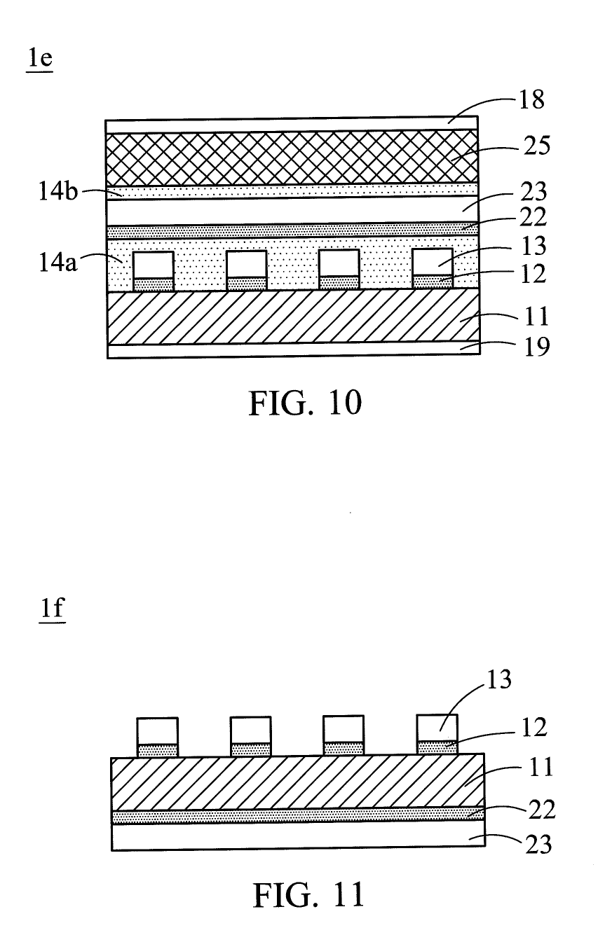

FIG. 10 shows a cross sectional view of a touch panel of a fourth application example of the invention. The touch panel 1e includes the touch panel 1d structure shown in FIG. 9 and this portion is not described again.

The touch panel le further includes a top substrate 25 and a second filler layer 14b. The top substrate 25 is bonded over a side of the first substrate having the second transparent conductive film 22 and the second stack layer 23. The second filler layer 14b and the first filler layer 14a have the same material, and thus are not described again.

The touch panel 1e can further include a top layer 18 formed over the top substrate 25 and a bottom layer 19 formed under the first substrate 11. The materials of the top layer 18 and the bottom layer 19 are described in the first application example, and thus are not described again.

### Fifth Application Example

FIG. 11 shows a cross sectional view of a touch panel of a fifth application example of the invention. The touch panel 1f includes a first substrate 11, a first transparent conductive film 12 and a first stack layer 13. The first substrate 11, the first transparent conductive film 12 and the first stack layer 13 are the same as those disclosed in the touch panel 1a shown in FIG. 3, and thus are not described again.

The touch panel if further includes a second transparent conductive film 22 and a second stack layer 23, and both have a second pattern. The second transparent conductive film 22 and the second stack layer 23 are sequentially formed on another side of the first substrate 11. The materials of the second transparent conductive film 22 and the second stack layer 23 are described in a previous application example, and thus are not described again. Referring to FIG. 10 again, the first transparent conductive film 12 and the first stack layer 13 have the same pattern (referred to a first pattern), and the second transparent conductive film 22 and the second stack layer 23 have the same pattern (referred to a second pattern), and thus are not described again.

### Sixth Application Example

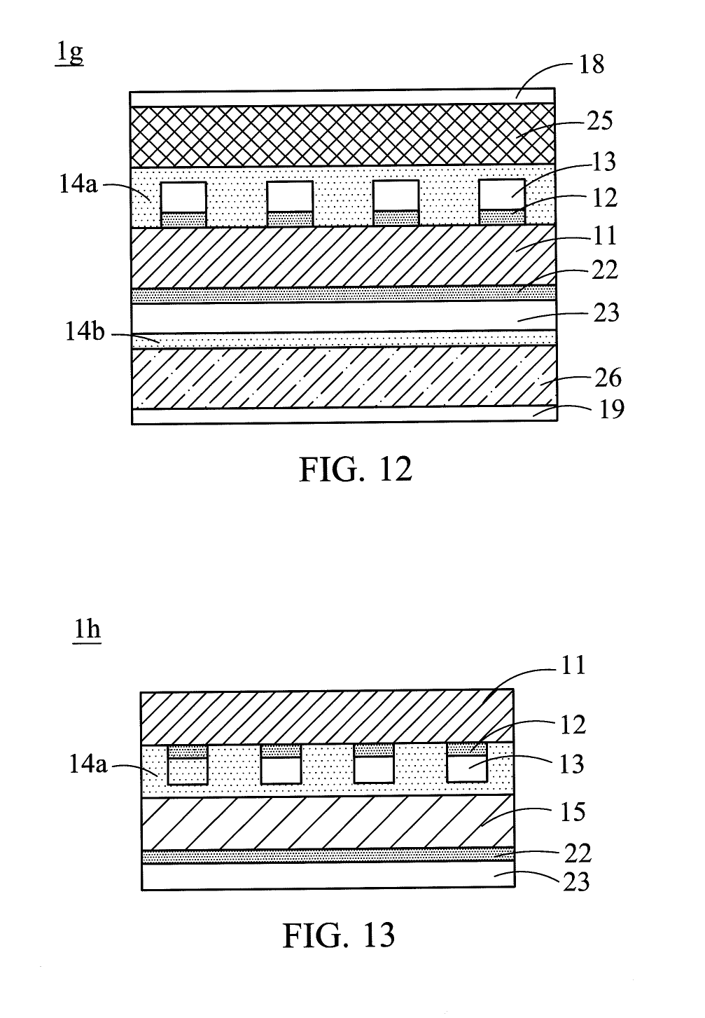

FIG. 12 shows a cross sectional view of a touch panel 1g of a sixth application example of the invention. The main portions of the touch panel if is the same as that disclosed in the fifth application example, and thus are not described again.

The touch panel 1g further includes a top substrate 25 and a first filler layer 14a. The top substrate 25 is bonded to a side of the first substrate 11 having the first transparent conductive film 12 and the first stack layer 13 through the first filler layer 14a.

The touch panel 1g further includes a bottom substrate 26 and a second filler layer 14b. The bottom substrate 26 is bonded to a side of the first substrate 11 having the second transparent conductive film 22 and the second stack layer 23 through the second filler layer 14b. The first substrate 11, the top substrate 25 and the bottom substrate 26 can include the same material or different materials.

The touch panel 1g can further include a top layer 18 formed over the top substrate 25. The touch panel 1g can further include a bottom layer 19 formed under the bottom substrate 26. The top layer 18 and the bottom layer 19 are described in the first application example and thus are not described again.

### Seventh Application Example

FIG. 13 shows a cross sectional view of a touch panel of a seventh application example of the invention. The touch panel 1h mainly includes a first substrate 11 and a first transparent conductive film 12 and a first stack layer 13 formed at a side of the first substrate 11. The main structure of the touch panel of the example is the same as that of the touch panel 1a of the first application example and is not described again.

The touch panel 1h further includes a second substrate 15, a second transparent conductive film 22, a second stack layer 23 and a first filler layer 14a. The second stack layer 23 and the second transparent conductive film 22 have the same pattern (referred to a second pattern and shown in FIG. 10) and are sequentially formed on a side of the second substrate 15. Another side of the second substrate 15 is bonded under a side of the first substrate 11 having the first transparent conductive film 12 and the first stack layer 13 through the first filler layer 14a. The second substrate 15 can be a glass substrate, a plastic substrate or a transparent insulating substrate. The material of the first filler layer 14a has been described in the first application example, and thus is not described again.

### Eight Application Example

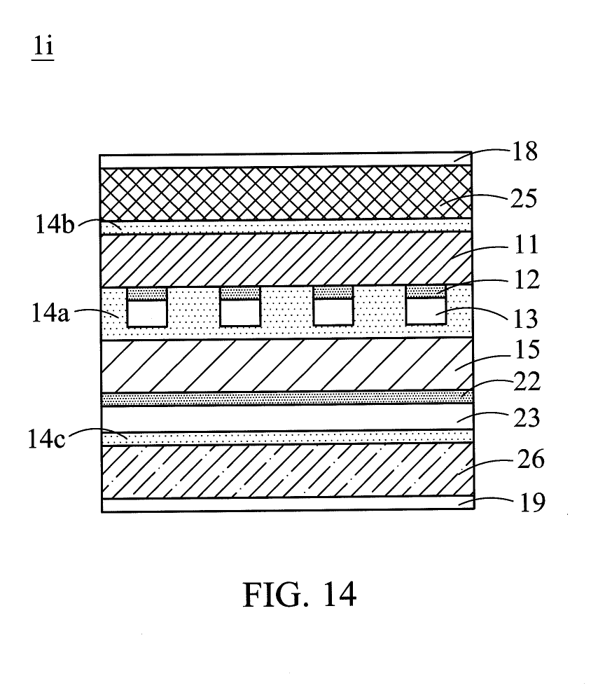

FIG. 14 shows a cross sectional view of a touch panel 1i of an eight application example of the invention. The primary structure of the touch panel 1h is the same as that shown in FIG. 13, and thus is not described again.

The touch panel 1i further includes a second filler layer 14b and a top substrate 25. The top substrate 25 is bonded over another side of the first substrate 11 through the second filler layer 14b. The touch panel 1i can further include a top layer 18 formed on the top substrate 25.

The touch panel 1i further includes a third filler layer 14c and a bottom substrate 26. The bottom substrate 26 is bonded under a side of the second substrate 15 having the second transparent conductive film 22 and the second stack layer 23 through the third filler layer 14c. The touch panel 1i can further include a bottom layer 19 formed under the bottom substrate 26. The second filler layer 14b and the third filler layer 14c can be dielectric layers, adhesion layers or pressure-sensitive adhesives. The second filler layer 14b, the third fuller layer 14c and the first filler layer 14a can formed of the same material or different materials, depending on actual design. The first substrate 11, the second substrate 15, the top substrate 25, and the bottom substrate 26 can be glass substrates, plastic substrates or transparent insulating substrates. The first substrate 11, the second substrate 15, the top substrate 25, and the bottom substrate 26 can be formed of the same material or different materials.

According to the description above, the invention forms a stack layer having the same patterns on the pattern region of the transparent conductive film to reduce reflectivity difference of the transparent conductive film in the pattern region and the non-pattern region. Therefore, the human eye can not see patterns in the pattern region.

In addition, the stack layer formed on the transparent conductive film can also protect the transparent conductive film from being scratched or lines from breaking.

The stack layer formed on the transparent conductive film can keep the transparent conductive film from coming into contact with oxygen to improve conductivity and uniformity of the transparent conductive film and prevent the transparent conductive film from degradation.

While the invention has been described by way of example and in terms of the preferred embodiments, it is to be understood that the invention is not limited to the disclosed embodiments. It is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A touch panel comprising:
a first substrate;
a first transparent conductive film having a first pattern and formed at a side of the first substrate; and
a first stack layer having the first pattern stacked on the first transparent conductive film.

2. The touch panel as claimed in claim 1, further comprising a top substrate and a first filler layer, wherein the first filler layer is formed at a side of the substrate having the first transparent conductive film, and the top substrate is formed on the filler layer.

3. The touch panel as claimed in claim 1, further comprising a first filler layer and a top layer sequentially formed on a side of the substrate having the first transparent conductive film and the first stack layer.

4. The touch panel as claimed in claim 1, further comprising a top substrate, a first filler layer, bottom substrate and a second filler layer, wherein the top substrate is bonded to another side of the substrate through the first filler layer, and the bottom substrate is bonded to the side of the first substrate having the first transparent conductive film and the first stack layer.

5. The touch panel as claimed in claim 1, further comprising a first filler layer formed over a side of the substrate having the first transparent conductive film and the first stack layer.

6. The touch panel as claimed in claim 5, further comprising:
a second transparent conductive film having a second pattern; and
a second stack layer having the second pattern, wherein the second transparent conductive film and the second stack layer are sequentially formed on the first filler layer.

7. The touch panel as claimed in claim 6, further comprising a top substrate and a second filler layer, wherein the top substrate is bonded to a side of the substrate having the second transparent conductive film and the second stack layer through the second filler layer.

8. The touch panel as claimed in claim 1, further comprising a second transparent conductive film and a second stack layer, wherein both the second transparent conductive film and the second stack layer have the second pattern, and the second transparent conductive film and the second stack layer are sequentially formed on another side of the first substrate.

9. The touch panel as claimed in claim 8, further comprising a top substrate and a first filler layer, wherein the top substrate is bonded to a side of the top substrate having the second transparent conductive film and the second stack layer through the first filler layer.

10. The touch panel as claimed in claim 8, further comprising a bottom substrate and a second filler layer, wherein the bottom substrate is bonded to a side of the top substrate having the second transparent conductive film and the second stack layer through the second filler layer.

11. The touch panel as claimed in claim 1, further comprising a second substrate, a second transparent conductive film and a second stack layer, wherein the second stack layer and the second transparent conductive film have the second pattern and are sequentially formed on a side of the second substrate.

12. The touch panel as claimed in claim 11, further comprising a first filler layer, wherein the another side of the second substrate is bonded under a side of the first substrate having the first transparent conductive film and the first stack layer through the first filler layer.

13. The touch panel as claimed in claim 12, further comprising a second filler layer and a top substrate, wherein the top substrate is bonded over another side of the first substrate through the second filler layer.

14. The touch panel as claimed in claim 12, further comprising a third filler layer and a bottom substrate, wherein the bottom substrate is bonded under a side of the second substrate having the second transparent conductive film and the second stack layer through the third filler layer.

15. The touch panel as claimed in claim 1, wherein the first stack layer is a composite layer, the first stack layer comprises alternately stacked high-refraction-index and low-refraction-index films, and the first stack layer comprises alternately stacked silicon oxide thin films and silicon nitride thin films.

16. The touch panel as claimed in claim 6, wherein the second stack layer is a composite layer, the second stack layer comprises alternately stacked high-refraction-index and low-refraction-index films, and the second stack layer comprises alternately stacked silicon oxide thin films and silicon nitride thin films.

17. The touch panel as claimed in claim 2, further comprising a top layer formed on the top substrate, the top layer is a single anti-reflection layer, a anti-reflection multi-layer, an anti glare layer, an anti subbing layer, a hardening layer or fingerprint preventing layer.

18. The touch panel as claimed in claim 1, further comprising a bottom layer formed under the bottom substrate, wherein the bottom layer is a noise preventing layer comprising a second transparent conductive film, a single anti-reflection layer, a anti-reflection multi-layer, an anti glare layer, an anti subbing layer, a hardening layer or fingerprint preventing layer.

19. The touch panel as claimed in claim 1, wherein the first pattern comprises at least one first transparent conductive strip extending along a first direction, and the second pattern comprises at least one second transparent conductive strip extending along a second direction, the first direction and the second direction are substantially perpendicular.

20. The touch panel as claimed in claim 19, wherein the first transparent conductive strip and the second transparent conductive strip are formed of serially connected rhombuses.
